(19) United States
(12) Patent Application Publication
(10) Pub. No.: US 2018/0032540 A1
(43) Pub. Date: Feb. 1, 2018

(54) METHOD AND SYSTEM FOR IMPLEMENTING REVERSE DIRECTORY LOOKUP USING HASHED FILE METADATA

(71) Applicant: Dell Products L.P., Round Rock, TX (US)

(72) Inventors: Lev GELDMAN, Tel Aviv (IL); Ofir CARNY, Herzeliya (IL); Daniel KRAUTHGAMER, Tel Aviv (IL)

(21) Appl. No.: 15/221,887

(22) Filed: Jul. 28, 2016

(51) Int. Cl. G06F 17/30

(52) U.S. Cl. CPC G06F 17/30109; G06F 17/30097

(57) ABSTRACT

A method and a system for implementing a reverse directory lookup using hash table, the method comprising: calculating using a hash function, a hash value of file name, upon creating a new file in a file system; writing the calculated hash value to the metadata of the file; reading the hash value at a meta data of a file of a desirable identifier (ID), responsive to an inquiry of a file name associated with the desirable ID; and searching for a corresponding file name for the desirable ID at a bucket storing all files associated with this bucket according to their filename's hash values, based on a hash function.

### FIELD OF THE INVENTION

The present invention relates generally to the field of managing a file system, and more particularly to implementing a reverse directory lookup in file systems.

### BACKGROUND OF THE INVENTION

Prior to the background of the invention being set forth, it may be helpful to provide definitions of certain terms that will be used hereinafter.

The term “file” as used herein is defined as a container for storing data.

The term “directory” as used herein is defined as a cataloging structure of a file system which contains references (known as “filenames”) to other files and other directories.

The term “path” as used herein is defined as a sequence of filenames leading from root directory to the specific file.

The term “ID” as used herein is defined as a unique file identifier (ID) used internally by a file system to identify files and directories.

The term “directory lookup” as used herein is defined as a process of resolution of an ID from a filename in the directory.

The term “reverse directory lookup” as used herein is defined as a process of resolution of filename in a directory from an ID.

FIG. 1 is a block diagram illustrating a process implemented on a non-transitory computer readable medium 20 executed on a computer processor 10 for organizing data in file systems in accordance with the prior art. Diagram 100 illustrates a hierarchical structure of directories. User usually identifies the files according to their paths. In response to carrying out path resolution, the user receives an ID that serves as an identification token of the file. From this point on, all client requests and internal manipulations on the file are carried out based on the ID rather than the path. A directory may reference its contents using filenames and internally serves as a data structure to perform the resolution of ID from a filename.

FIG. 2 is a block diagram illustrating a very common implementation of directories as hash table implemented on a non-transitory computer readable medium 20 executed on a computer processor 10 in accordance with the prior art. In a hash table implementation, all the filenames that a specific directory contains are divided into “buckets” according to a numeric result of a hash function that depends only on the filename itself. In order to resolve the ID by the filename (or conclude that it is not present), one needs to compute the hash value of this name and read only the bucket that corresponds to this value. This is a very scalable and efficient approach because name resolution requires reading of one bucket only and is independent of the total number of entries in the directory (hash table).

In some applications, there is a need to retrieve filename from the given ID (Reverse directory lookup). For example, for auditing purposes, it may be required to receive a report on every file that was accessed by the file system. A file system can easily report accessed IDs, but for auditing purposes it is usually required to report paths.

Directory lookup effectiveness is critical for the system performance, and so directory implementations are optimized for lookup. In the case of reverse lookup, the name of the file is not known, and the only way to find where the ID appears is to read all the buckets sequentially from the parent directory and to check every single entry until the match is found. Parent directory ID is stored on file meta data.

A trivial solution for this problem would be adding the filename to the file metadata. This will indeed improve the path resolution efficiency because it will allow us to read ONLY the bucket relevant for this filename, but it has a major flaw. The filename itself requires a big amount of memory relative to the amount of other metadata preserved for each file. Inflating the metadata size will reduce significantly the amount of metadata objects in cache and this will reduce the cache effectiveness.

### SUMMARY OF THE INVENTION

Some embodiments of the present invention implement a reverse directory lookup using hash table, the method comprising: calculating using a hash function, a hash value of file metadata, upon creating a new file in a file system; writing the calculated hash value to the metadata of the file; reading the hash value at a meta data of a file of a desirable ID, responsive to an inquiry of a file name associated with the desirable ID; and searching for a corresponding file name for the desirable ID at a bucket storing all files associated with the hash value, based on a hash function.

Some embodiments of the present invention provide a system for implementing a reverse directory lookup using hash table, the system including: a computer processor; a data structure executed on said computer processor and configured to hold directories of files in a file system; a hash function module executed on said computer processor and configured to calculate a hash value of file name, upon creating a new file in said file system; a writer executed on said computer processor and configured to write the calculated hash value to the metadata of the file; a reader executed on said computer processor and configured to: read the hash value at a meta data of a file of a desirable ID, responsive to an inquiry of a file name associated with the desirable ID; and search for a corresponding file name for the desirable ID at a bucket storing all files associated with this bucket according to their filename's hash values, based on a hash function.

According to some embodiments of the present invention, the calculating of the hash value of file name, may be repeated upon renaming of the file.

According to some embodiments of the present invention, the searching may be carried out by comparing the desirable ID of the file IDs on the bucket and deriving the file name that corresponds with the desirable ID.

According to some embodiments of the present invention, the method may be usable for auditing a file system.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 is a block diagram illustrating a block diagram of a system in accordance with the prior art;

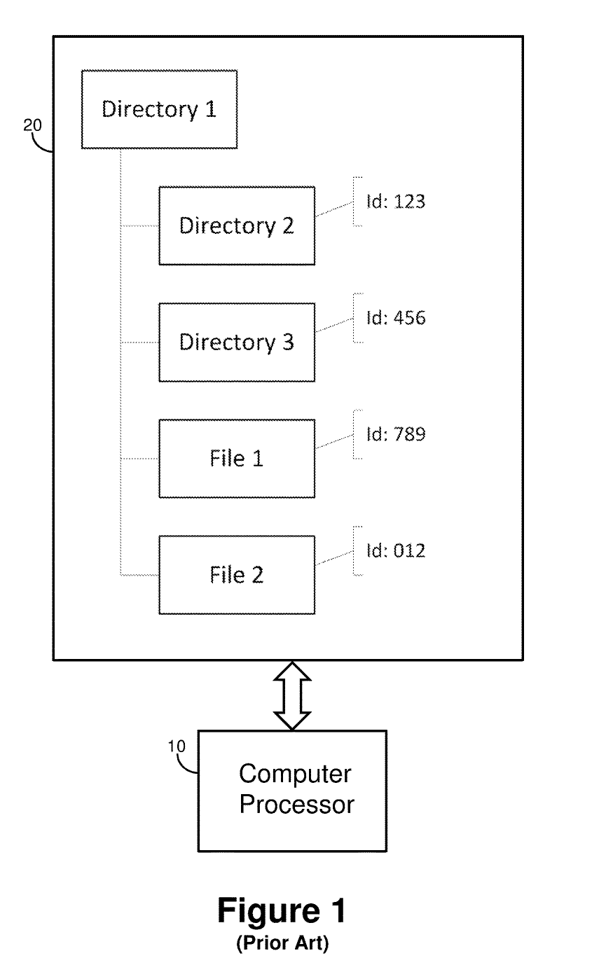

FIG. 2 is a block diagram illustrating an exemplary directory lookup in accordance with the prior art;

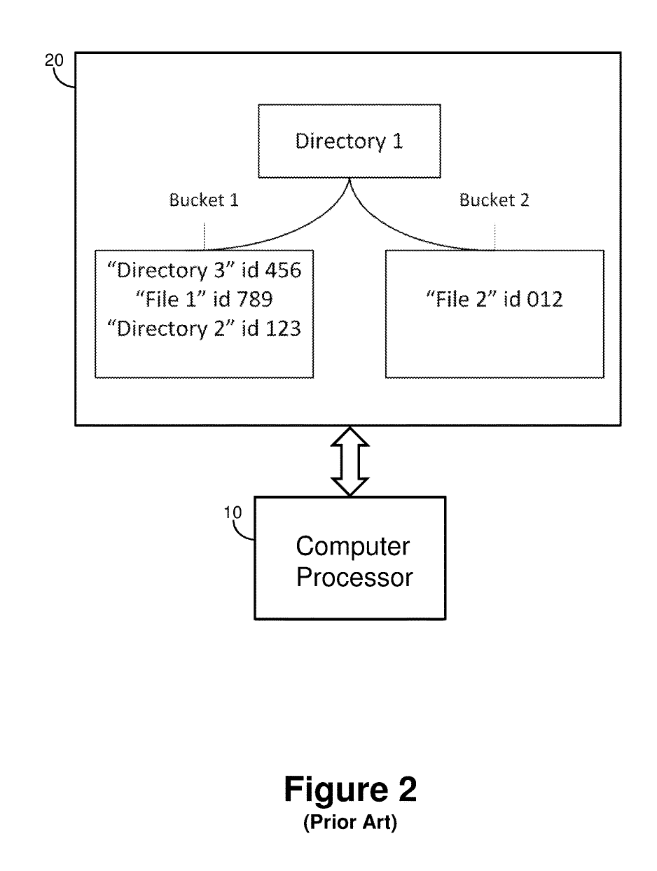

FIG. 3 is a diagram illustrating an aspect of the system in accordance with embodiments of the present invention; and

FIG. 4 is a flow chart diagram illustrating an aspect of the method in accordance with embodiments of the present invention.

It may be appreciated that, for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE INVENTION

In the following description, various aspects of the present invention may be described. For purposes of explanation, specific configurations and details are set forth in order to provide a thorough understanding of the present invention. However, it may also be apparent to one skilled in the art that the present invention may be practiced without the specific details presented herein. Furthermore, well known features may be omitted or simplified in order not to obscure the present invention.

Unless specifically stated otherwise, as apparent from the following discussions, it is appreciated that throughout the specification discussions utilizing terms such as “processing,” “computing,” “calculating,” “determining,” or the like, refer to the action and/or processes of a computer or computing system, or similar electronic computing device, that manipulates and/or transforms data represented as physical, such as electronic, quantities within the computing system's registers and/or memories into other data similarly represented as physical quantities within the computing system's memories, registers or other such information storage, transmission or display devices.

Some embodiments of the present invention provide a way to enhance the effectiveness of the reverse lookup in systems where directory is implemented as a hash table.

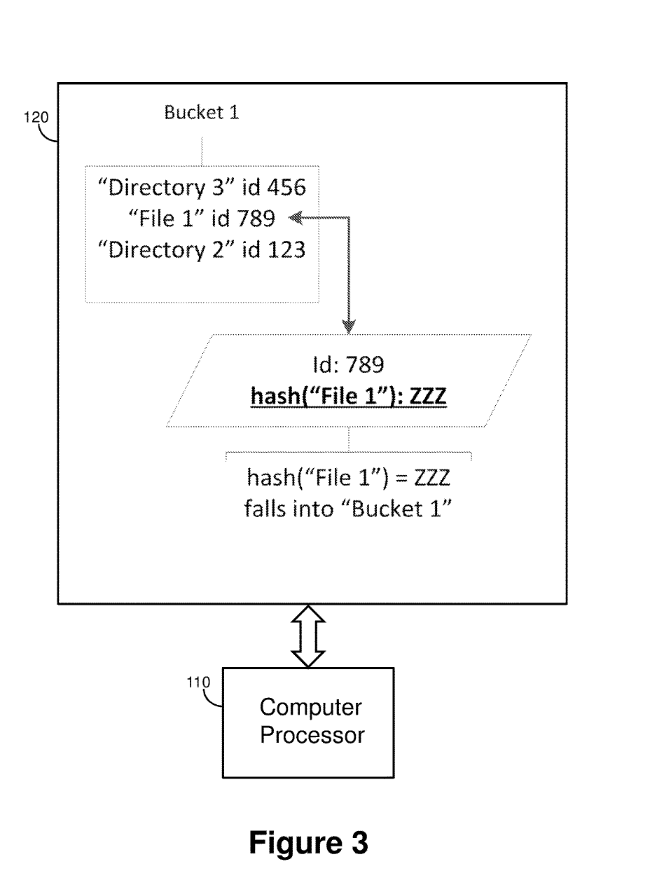

FIG. 3 is a diagram illustrating an aspect of a system in accordance with embodiments of the present invention. The system includes a computer processor 110 and a non-transitory computer readable medium 120 having a reverse directory lookup database implemented thereon. In accordance with some embodiments of the present invention, the performance of the reverse directory lookup database is enhanced by adding a hash value to the file's metadata. In this case, reverse lookup will start by reading the file metadata and returning its hash value. Then, only the corresponding bucket of the directory can be read. This also makes reverse lookup scalable. The hash value would be computed and stored during the file creation and updated during rename operations. This adds some overhead as metadata of the file would be rewritten, yet it is assumed that rename operations are relatively rare and so the accumulated effect of the overhead should be negligible. For the files created previously and lacking the hash value in metadata, reverse lookup will continue to work without the effectiveness enhancement.

### Example

Assuming there is a directory containing 10000 files, without the enhancement according to the embodiments of the present invention, the reverse lookup for each file in the directory will require comparison of file's ID with the IDs of all other files in the directory−average of 10000/2=5000 comparison operations for each file. This will total in 10000*5000=50M comparison operations.

On the contrary, with the enhancement according to the embodiments of the present invention, the reverse lookup for each file will in the directory will compare its ID only with the IDs of the files in the same bucket. This number is bounded by a constant. Let's take 100 as a number of names in the bucket. Then, for each file, an average of 100/2=50 comparisons need to be performed. This will total in 10000*50=500K comparison operations.

Advantageously, auditing system performing reporting of accesses to all the files in this directory will decently benefit in performance even in this simple and very common setup.

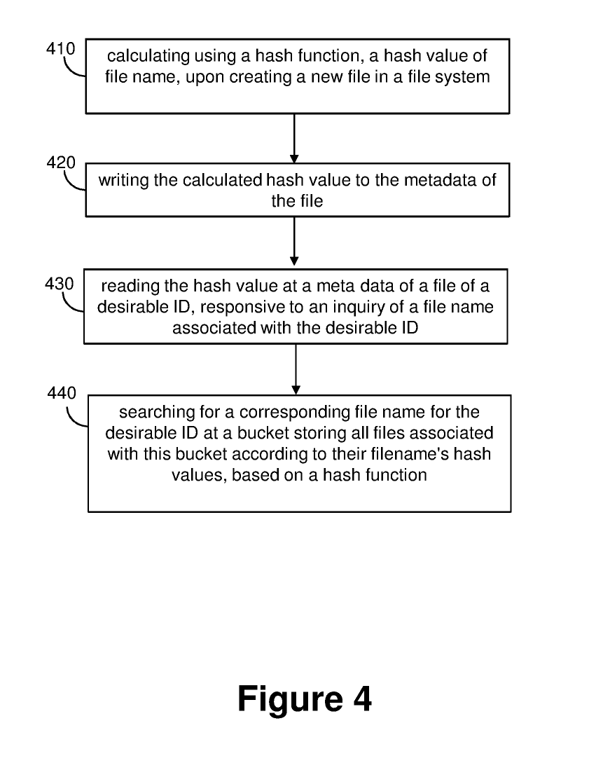

FIG. 4 is a flow chart diagram illustrating an aspect of the method in accordance with some embodiments of the present invention. The method in accordance with some embodiments of the present invention may include: calculating using a hash function, a hash value of file name, upon creating a new file in a file system 410; writing the calculated hash value to the metadata of the file 420; reading the hash value at a meta data of a file of a desirable ID, responsive to an inquiry of a file name associated with the desirable ID 430; and searching for a corresponding file name for the desirable ID at a bucket storing all files associated with this bucket according to their filename's hash values, based on a hash function 440.

In order to implement the method according to some embodiments of the present invention, a computer processor may receive instructions and data from a read-only memory or a random access memory or both. At least one of aforementioned steps is performed by at least one processor associated with a computer. The essential elements of a computer are a processor for executing instructions and one or more memories for storing instructions and data. Generally, a computer may also include, or be operatively coupled to communicate with, one or more mass storage devices for storing data files. Storage modules suitable for tangibly embodying computer program instructions and data include all forms of non-volatile memory, including by way of example semiconductor memory devices, such as EPROM, EEPROM, and flash memory devices and also magneto-optic storage devices. Some embodiments of the present invention may be implemented as a non-transitory computer readable medium.

As may be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in base band or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wire-line, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described above with reference to flowchart illustrations and/or portion diagrams of methods, apparatus (systems) and computer program products according to some embodiments of the invention. It may be understood that each portion of the flowchart illustrations and/or portion diagrams, and combinations of portions in the flowchart illustrations and/or portion diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or portion diagram portion or portions.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or portion diagram portion or portions.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or portion diagram portion or portions.

The aforementioned flowchart and diagrams illustrate the architecture, functionality, and operation of possible implementations of systems, methods and computer program products according to various embodiments of the present invention. In this regard, each portion in the flowchart or portion diagrams may represent a module, segment, or portion of code, which includes one or more executable instructions for implementing the specified logical function(s). It should also be noted that, in some alternative implementations, the functions noted in the portion may occur out of the order noted in the figures. For example, two portions shown in succession may, in fact, be executed substantially concurrently, or the portions may sometimes be executed in the reverse order, depending upon the functionality involved. It may also be noted that each portion of the portion diagrams and/or flowchart illustration, and combinations of portions in the portion diagrams and/or flowchart illustration, can be implemented by special purpose hardware-based systems that perform the specified functions or acts, or combinations of special purpose hardware and computer instructions.

In the above description, an embodiment is an example or implementation of the inventions. The various appearances of “one embodiment,” “an embodiment” or “some embodiments” do not necessarily all refer to the same embodiments.

Although various features of the invention may be described in the context of a single embodiment, the features may also be provided separately or in any suitable combination. Conversely, although the invention may be described herein in the context of separate embodiments for clarity, the invention may also be implemented in a single embodiment.

Reference in the specification to “some embodiments”, “an embodiment”, “one embodiment” or “other embodiments” means that a particular feature, structure, or characteristic described in connection with the embodiments is included in at least some embodiments, but not necessarily all embodiments, of the inventions.

It is to be understood that the phraseology and terminology employed herein is not to be construed as limiting and are for descriptive purpose only.

The principles and uses of the teachings of the present invention may be better understood with reference to the accompanying description, figures and examples.

It is to be understood that the details set forth herein do not construe a limitation to an application of the invention.

Furthermore, it is to be understood that the invention can be carried out or practiced in various ways and that the invention can be implemented in embodiments other than the ones outlined in the description above.

It is to be understood that the terms “including”, “comprising”, “consisting” and grammatical variants thereof do not preclude the addition of one or more components, features, steps, or integers or groups thereof and that the terms are to be construed as specifying components, features, steps or integers.

If the specification or claims refer to “an additional” element, that does not preclude there being more than one of the additional element.

It is to be understood that where the claims or specification refer to “a” or “an” element, such reference is not be construed that there is only one of that element.

It is to be understood that where the specification states that a component, feature, structure, or characteristic “may”, “might”, “can” or “could” be included, that particular component, feature, structure, or characteristic is not required to be included.

Where applicable, although state diagrams, flow diagrams or both may be used to describe embodiments, the invention is not limited to those diagrams or to the corresponding descriptions. For example, flow need not move through each illustrated box or state, or in exactly the same order as illustrated and described.

Methods of the present invention may be implemented by performing or completing manually, automatically, or a combination thereof, selected steps or tasks.

The term “method” may refer to manners, means, techniques and procedures for accomplishing a given task including, but not limited to, those manners, means, techniques and procedures either known to, or readily developed from known manners, means, techniques and procedures by practitioners of the art to which the invention belongs.

The descriptions, examples, methods and materials presented in the claims and the specification are not to be construed as limiting but rather as illustrative only.

Meanings of technical and scientific terms used herein are to be commonly understood as by one of ordinary skill in the art to which the invention belongs, unless otherwise defined.

The present invention may be implemented in the testing or practice with methods and materials equivalent or similar to those described herein.

Any publications, including patents, patent applications and articles, referenced or mentioned in this specification are herein incorporated in their entirety into the specification, to the same extent as if each individual publication was specifically and individually indicated to be incorporated herein. In addition, citation or identification of any reference in the description of some embodiments of the invention shall not be construed as an admission that such reference is available as prior art to the present invention.

While the invention has been described with respect to a limited number of embodiments, these should not be construed as limitations on the scope of the invention, but rather as exemplifications of some of the preferred embodiments. Other possible variations, modifications, and applications are also within the scope of the invention. Accordingly, the scope of the invention should not be limited by what has thus far been described, but by the appended claims and their legal equivalents.

1. A system for implementing a reverse directory lookup using hash table, the method comprising:
a computer processor;
a data structure executed on said computer processor and configured to hold directories of files in a file system;
a hash function module executed on said computer processor and configured to calculate a hash value of file name, upon creating a new file in said file system;
a writer executed on said computer processor and configured to write the calculated hash value to the metadata of the file; and
a reader executed on said computer processor and configured to:
read the hash value at a meta data of a file of a desirable ID, responsive to an inquiry of a file name associated with the desirable ID; and
search for a corresponding file name for the desirable ID at a bucket storing all files associated with this bucket according to their filename's hash values, based on a hash function.

2. The system according to claim 1, wherein the calculating of the hash value of file name, is repeated upon renaming of the file.

3. The system according to claim 1, wherein the searching is carried out by comparing the desirable ID of the file IDs on the bucket and deriving the file name that corresponds with the desirable ID.

4. The system according to claim 1, wherein the method is usable for auditing a file system.

5. A method for implementing a reverse directory lookup using hash table, the method comprising:
calculating using a hash function, a hash value of file name, upon creating a new file in a file system;
writing the calculated hash value to the metadata of the file;
reading the hash value at a meta data of a file of a desirable ID, responsive to an inquiry of a file name associated with the desirable ID; and
searching for a corresponding file name for the desirable ID at a bucket storing all files associated with this bucket according to their filename's hash values, based on a hash function.

6. The method according to claim 1, wherein the calculating of the hash value of file name, is repeated upon renaming of the file.

7. The method according to claim 1, wherein the searching is carried out by comparing the desirable ID of to file IDs on the bucket and deriving the file name that corresponds with the desirable ID.

8. The method according to claim 1, wherein the method is usable for auditing a file system.

9. A non-transitory computer readable medium comprising a set of instructions that, when executed, cause at least one processor to:
calculate using a hash function, a hash value of file name, upon creating a new file in a file system;
write the calculated hash value to the metadata of the file;
read the hash value at a meta data of a file of a desirable ID, responsive to an inquiry of a file name associated with the desirable ID; and
search for a corresponding file name for the desirable ID at a bucket storing all files associated with this bucket according to their filename's hash values, based on a hash function.

10. The non-transitory computer readable medium according to claim 9, wherein the calculating of the hash value of file name, is repeated upon renaming of the file.

11. The non-transitory computer readable medium according to claim 9, wherein the searching is carried out by comparing the desirable ID of to file IDs on the bucket and deriving the file name that corresponds with the desirable ID.

12. The non-transitory computer readable medium according to claim 9, wherein the non-transitory computer readable medium is usable for auditing a file system.
